(19) United States
(12) Patent Application Publication
(10) Pub. No.: US 2011/0055917 A1
(43) Pub. Date: Mar. 3, 2011

(54) VALID ACCESS TO MOBILE DEVICE APPLICATION

(75) Inventor: Olof Gunnar WICKSTROM, Lund (SE)

(73) Assignee: Sony Ericsson Mobile Communications AB, Lund (SE)

(21) Appl. No.: 12/549,545

(22) Filed: Aug. 28, 2009

(51) Int. Cl. G06F 21/22

(52) U.S. Cl. 726/17; 455/418

(57) ABSTRACT

A method in a mobile device, for verifying valid access to at least one software application comprised in the mobile device. The mobile device comprises a unique hardware manufacturer identity code. The at least one software application comprises a list of at least one valid unique hardware manufacturer identity code. First, a request to access to the at least one software application is received. Then it requests the unique hardware manufacturer identity code of the mobile device. The next step is to receive the unique hardware manufacturer identity code and to extract at least a part of the identity code identifying the manufacturer of the mobile device. The extracted part of the identity code with valid codes comprised in the software application is compared. If the extracted part of the identity code corresponds to the valid code, access to the at least one software application is provided to the user.

### TECHNICAL FIELD

The invention generally relates to a method in a mobile device, a mobile device and a software application and, more particularly, to verifying valid access to at least one software application residing in a mobile device.

### BACKGROUND

Mobile devices, such as cell phones, often include software applications or programs that enable users to access their email accounts, play music and games, or perform other functions, such as obtain directions to a place of interest, sports scores, or obtain weather-related information. Such applications have made portable communication devices increasingly important to users. These applications may either be installed by the manufacturer of the mobile device, to downloaded and/or sideloaded by the user to the mobile device.

The applications can be open source applications or closed-source applications. Mobile devices using open source operative systems effectively consider all applications on the device as equal. To be able to run applications on such mobile devices, the only requirement is that the right version of the operating system is present. The developers of closed-source applications, in particular, may desire some degree of control over the use of their applications. For example, in the situation in which a mobile telephone is manufactured to include an application (i.e., loaded on the mobile telephone prior to sale) or when the usage of the application incurs a cost to the application developer (e.g., through license fees), the application developer and/or mobile device manufacturer may wish to restrict the use of particular applications to mobile devices from a particular mobile manufacturer, only. However, there is a challenge regarding copying closed-source applications to mobile devices made by other manufacturers, which decreases users' incentive to buy a mobile device from a particular manufacturer because they can use these particular applications in other manufacturer's devices.

To identify an individual mobile device, a unique serial number called International Mobile Equipment Identity, IMEI, may be assigned to the device. As known by a person skilled in the art, IMEI is standardized by ETSI and 3GPP, and mobile devices which do not follow these standards may not have an IMEI. The IMEI number is used by the network to identify valid mobile devices. IMEI identifies the device, not the user (the user is identified by an International Mobile Subscriber Identity, IMSI), by a 15 digit number and includes information about the source of the mobile device, the model, and serial number.

### SUMMARY

According to one embodiment, a method is performed in a mobile device, for verifying valid access to at least one software application residing in the mobile device. The mobile device may include a unique hardware manufacturer identity code. The at least one software application comprises a list of at least one valid unique hardware manufacturer identity code. First, the method comprises the step of receiving a request to access the at least one software application. Then, the unique hardware manufacturer identity code of the mobile device is requested and received. At least a part of the identity code identifying the manufacturer of the mobile device is extracted. The next step is to compare the extracted part of the identity code with valid codes comprised in the software application. Finally, access to the at least one software application is provided if the extracted part of the identity code corresponds to the valid code.

In an alternative embodiment of the present solution, the method comprises the step of indicating invalidity if the code is not corresponding to the valid code.

In further an alternative embodiment of the present solution, the method comprises the step of denying access to the at least one software application if the code is not corresponding to the valid code.

In yet an alternative embodiment of the present solution a limited access is provided to the at least one software application if the code is not corresponding to the valid code.

In still an alternative embodiment of the present solution the at least one software application is deleted if the code is not corresponding to the valid code.

In further an alternative embodiment of the present solution the unique hardware manufacturer identity code is an International Mobile Equipment Identity, “IMEI”.

In a second aspect of the present solution there is provided a mobile device for verifying valid access to at least one software application. The mobile device comprises a unique hardware manufacturer identity code. The at least one software application comprises a list of at least one valid unique hardware manufacturer identity codes. The mobile device comprises a memory unit comprising the at least one software application. The mobile device further comprises a processing unit adapted to receive a request to access to the at least one software application, and to request and receive the unique hardware manufacturer identity code of the mobile device. It is further adapted to extract at least a part of the identity code specifically identifying a manufacturer of the mobile device. The processing unit is also adapted to compare the extracted part of the identity code with valid codes comprised in the software application, and to provide access to the at least one software application if the extracted part of the identity code is valid.

In an alternative embodiment of the present solution the processing unit is further adapted to indicate invalidity if the code is not corresponding to the valid code.

In still an alternative embodiment of the present solution, the processing unit is further adapted to deny access to the at least one software application if the code is not corresponding to the valid code.

In yet an alternative embodiment of the present solution, the processing unit is further adapted to provide a limited access to the at least one software application if the code is not corresponding to the valid code.

In a further alternative embodiment of the present solution, the processing unit is further arranged to delete the at least one software application if the code is not corresponding to the valid code.

In yet an alternative embodiment of the present solution, the unique hardware manufacturer identity code is an International Mobile Equipment Identity, “IMEI”.

In a third aspect of the present solution there is provided a software application for verifying valid access to at least one software application comprised in the mobile device. The software application is stored on a computer-readable storage medium in the mobile device. The mobile device includes a unique hardware manufacturer identity code, and the at least one software application includes a list of at least one valid unique hardware manufacturer identity codes. The software applications comprising instruction sets for:
receiving a request to access to the at least one software application;
requesting the unique hardware manufacturer identity code of the mobile device;
receiving the unique hardware manufacturer identity code of the mobile device;
extracting at least a part of the identity code identifying the manufacturer of the mobile device;
comparing the extracted part of the identity code with valid codes comprised in the software application; and for
providing access to the at least one software application if the extracted part of the identity code corresponds to the valid code.

An advantage of an embodiment of the present invention is that it is possible to ensure that applications are used only on mobile devices from a designated manufacturer, i.e., preclude use of the applications on mobile devices from other manufacturers. By using the IMEI, the need to introduce any new or additional ID is obviated. The unique hardware manufacturer identity code, e.g., IMEI, is provided to the device as a standard practice, and does not have to be extraneously administered as part of and/or after the production process. This makes the present solution easy and cost effective, and it also requires very little central processing unit (CPU) power to operate. The usage of IMEI (in other areas) is well established and thus makes this usage easy to communicate.

The present solution is not limited to the features and advantages mentioned above. A person skilled in the art will recognize additional features and advantages upon reading the following detailed description. The solution can be modified in various obvious respects, all without departing from the solution. Accordingly, the drawings are to be regarded as illustrative in nature, and not as restrictive.

### BRIEF DESCRIPTION OF THE DRAWINGS

The solution will now be further described in more detail in the following detailed description by reference to the appended drawings illustrating embodiments of the solution, and in which:

FIG. 1 is a schematic block diagram illustrating a wireless communication network;

FIG. 2 is a diagram illustrating an exemplary mobile device;

FIG. 3 is a combined schematic signaling diagram and flowchart depicting embodiments of a method;

FIG. 4 is a flowchart illustrating embodiments of a method in a mobile device; and

FIG. 5 is a block diagram illustrating embodiments of a mobile device.

### DETAILED DESCRIPTION

Generally, the present solution may use a unique hardware manufacturer identity code to restrict the use of specific applications to mobile devices from a specific manufacturer.

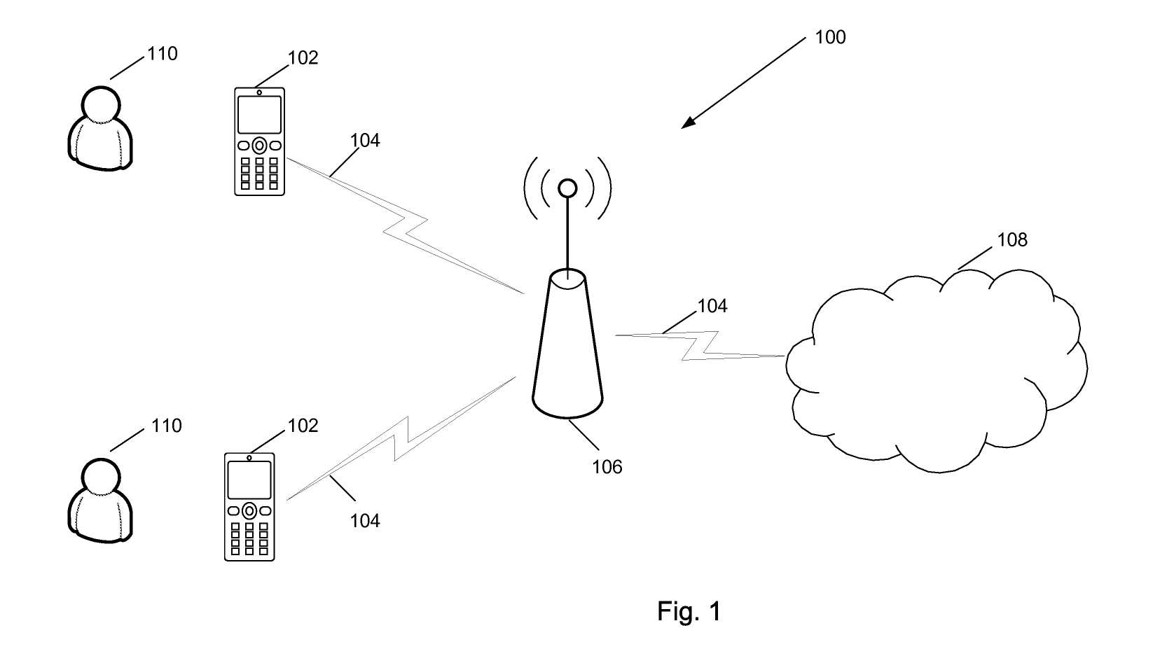

FIG. 1 is a schematic block diagram illustrating an example of a wireless communication network 100 in which mobile devices 102 (e.g., mobile phones) may communicate with each other using any suitable type of wireless communication link 104. Two mobile devices 102 are shown, but it should be understood that network 100 may include other numbers of mobile devices 102. Communication link 104 may use any suitable protocol depending on type and level of layer (e.g., as indicated by the OSI model), as understood by the person skilled in the art. Communication link 104 can be, for example, wired, wireless, or optical. Mobile devices 102 may be operated by users 110. Mobile devices 102 also may communicate with base station 106, which transmits and/or receives data to and/or from mobile devices 102. Mobile devices 102 may connect to a core network 108 (e.g., Internet service provider) providing, for example, Internet services to mobile devices 102. Other nodes or devices, such as switches, routers, etc., may be operable in wireless communication network 100.

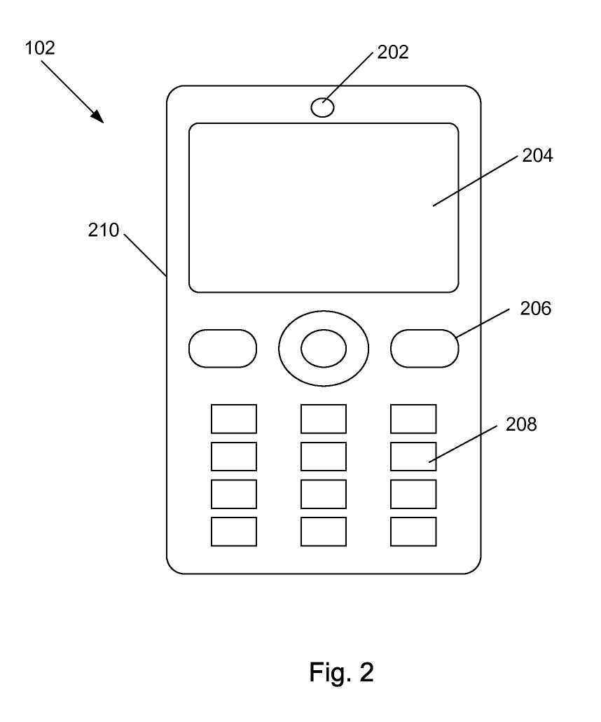

FIG. 2 is a drawing illustrating an example of mobile device 102. As shown, mobile device 102 may include a speaker 202, a display 204, control buttons 206, a keypad 208, and a housing 210. Mobile device 102 may also include additional devices or components, for example, a microphone and a camera (not shown). Speaker 202 may provide audible information to a user 110 of mobile device 102. Display 204 may provide visual information to user 110 of mobile device 102. For example, display 204 may render information regarding incoming or outgoing calls, media, games, phone books, the current time, etc. In one implementation, display 204 may present user 110 of mobile device 102 with a graphical user interface (GUI) for inputting various parameters associated with communication and image processing. Control buttons 206 may permit user 110 to interact with mobile device 102 to cause mobile device 102 to perform one or more operations, initiate an application and/or a feature, for instance. Keypad 208 may include a standard telephone keypad. Mobile devices 102 may include a touch screen, in an area where control buttons 206 and/or keypad 208 are shown on display 204, that is, in lieu of physical buttons or keys. The microphone may receive audible information from user 110. The camera may enable a user 110 to capture and store images (e.g., pictures, video clips). Housing 210 may provide a casing for supporting components of mobile device 102 and may protect the components from outside elements.

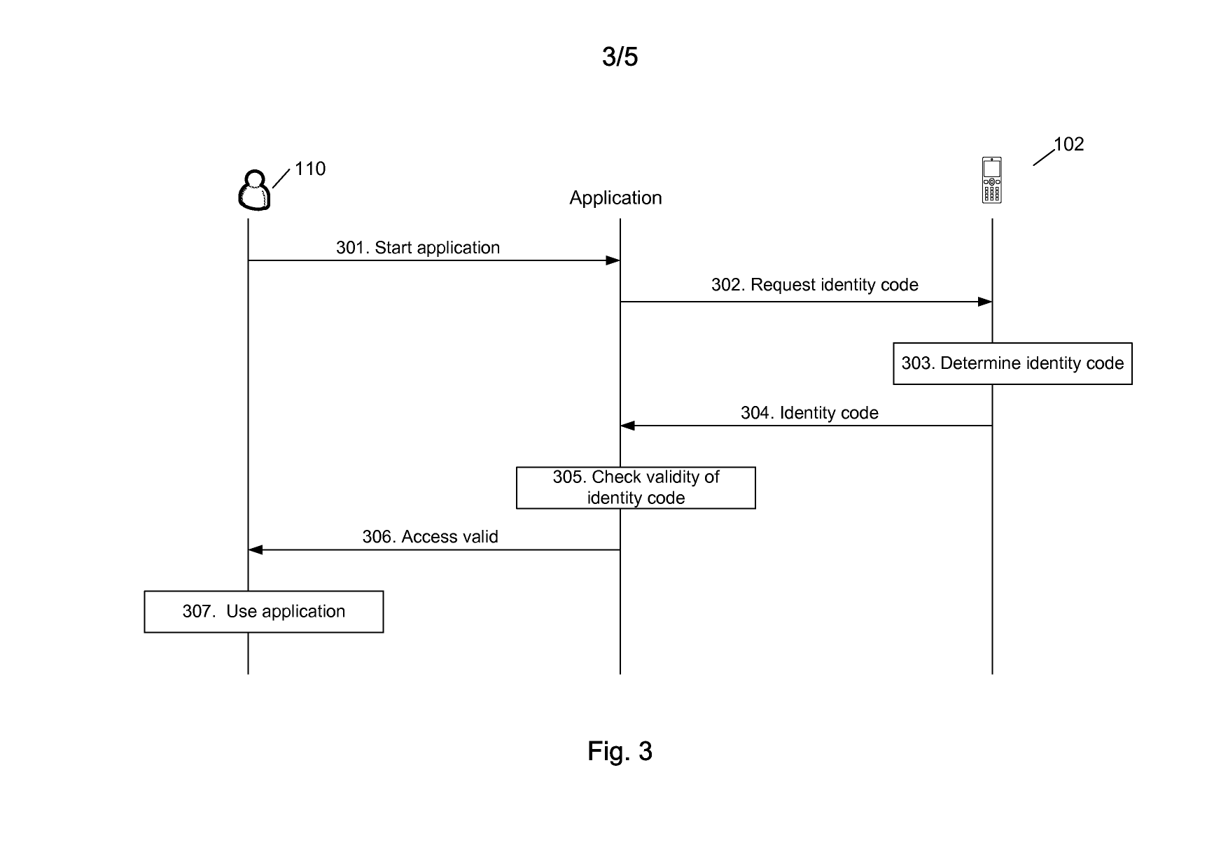

The present solution for validating access to at least one software application residing in mobile device 102, according to some embodiments, will now be described with reference to the combined signaling diagram and flowchart depicted in FIG. 3. The method may include the following steps, which steps may be performed in an order other than that described below:

### Step 301

User 110 of mobile device 102 invokes a software application, i.e., the application receives a request to access the application.

The software application may be stored in a computer-readable storage medium, such as the memory unit or other storage device of mobile device 102, and may include instruction sets to be executed on a processor of mobile device 102.

These applications may either be installed by the manufacturer of mobile device 102 and/or be downloaded and installed on the demand or sideloaded, by user 110, to mobile device 102. Regardless of how the applications are installed on mobile device 102, the application developer and/or the manufacturer of mobile device 102 may want to restrict the use of the applications to mobile devices 102 from a certain manufacturer, i.e., prevent copying of the applications to unapproved types of mobile devices 102.

The software application may include logic which determines whether the application is allowed to run on its host mobile device 102 or not.

By way of example, user 110 may select the application by using, for example, command buttons 206 on mobile device 102.

By way of example, mobile device 102 may include an application(s) that automatically starts-up upon powering on mobile device 102.

### Step 302

The application generates and sends a request for a unique identifier (e.g., unique hardware manufacturer identity code, to mobile device 102.

By way of example, the unique hardware manufacturer identity code is an International Mobile Equipment Identity (IMEI). The request may specify a type of unique identifier (e.g., an IMEI) that is to be provided.

### Step 303

Mobile device 102 may determine the unique identifier (e.g., unique hardware manufacturer identity code) associated with mobile device 102.

### Step 304

Mobile device 102 provides, responsive to the request, its unique hardware manufacturer identity code to the application.

### Step 305

The application checks the validity of the unique hardware manufacturer identity code provided by mobile device 102.

As mentioned earlier, the unique hardware manufacturer identity code may include information about origin, model, and/or serial number of mobile device 102. To check if an application is permitted to be executed on mobile device 102, it may be sufficient to check only a portion of the unique hardware manufacturer identity code, for example, indicative of the manufacturer of mobile device 102. Thus, the application may extract less than the entire unique hardware manufacturer identity code, for example, limited to identifying the particular manufacturer of mobile device 102.

To validate the unique hardware manufacturer identity code, the application may compare the extracted portion of the identifier with the set of valid codes (corresponding to approved manufacturers) stored in the application. If the valid codes stored in the application correspond to (e.g., match) the extracted portion of the identifier, the unique hardware manufacturer identity code may be deemed valid. A valid unique hardware manufacturer identity code means that the application is allowed to be executed on mobile device 102.

By way of example, the application may have a table identifying valid unique hardware manufacturer identity code(s). Alternatively, the application may have a table including the manufacturer specific parts of at least one valid unique hardware manufacturer identity code. This table may be provided or integrated in the application by the application developer.

By way of example, the application may have a range of unique hardware manufacturer identity codes, in which a valid unique hardware manufacturer identity code should fall within. A software developer might want to limit its application to be run on certain mobile devices 102 or if mobile device 102 is manufactured by original design manufacturers, ODM's, a valid identity code could be within a specified range of codes.

By way of example, the valid identity codes in the application might need to be updated. As most mobile devices today are regularly connected to the Internet, the update of the valid identity code may take place over communication link 104 using a secure protocol. The application may regularly check for updates or user 110 may manually check for updates.

### Step 306

The application gives user 110 access to the application upon a determination that the manufacturer identity code is valid, and user 110 may sees that the application starts on display 204 on mobile device 102.

In the case where the validation of the unique hardware manufacturer identity code is inconclusive and/or negative, the application may deny user 110 access to the application.

If the unique hardware manufacturer identity code was not valid, user 110 may see a message on display 204 on mobile device 102 informing user 110 that access to the application has been denied. The message may also indicate that the reason for access denial was an invalid unique hardware manufacturer identity code associated with the host mobile device 102.

By way of example, user 110 may not get any feedback to an invalid unique hardware manufacturer identity code, except from that the selected application cannot be opened.

By way of example, an invalid unique hardware manufacturer identity code may cause the unapproved application to be deleted from mobile device 102.

By way of example, a message may be generated and sent by mobile device 102 indicating that the application has been installed on an unapproved device. User 110 may or may not be made aware of the message.

By way of example, an invalid unique hardware manufacturer identity code may give user 110 a limited or partial access to the application. This limited access may give user 110 access to a prescribed number (i.e., less than all) of the features of the application and is intended to entice user 110 to desire full access of the application. Limited access may alternatively provide a full range of use of the application features, but for a limited amount of time, after which, the features are no longer operative. In either case, user 110 may be enticed by the experience to buy an approved mobile device 102 from designated a manufacturer(s).

### Step 307

Based on a result of the validation process, user 110 starts using the application in full or provisional access.

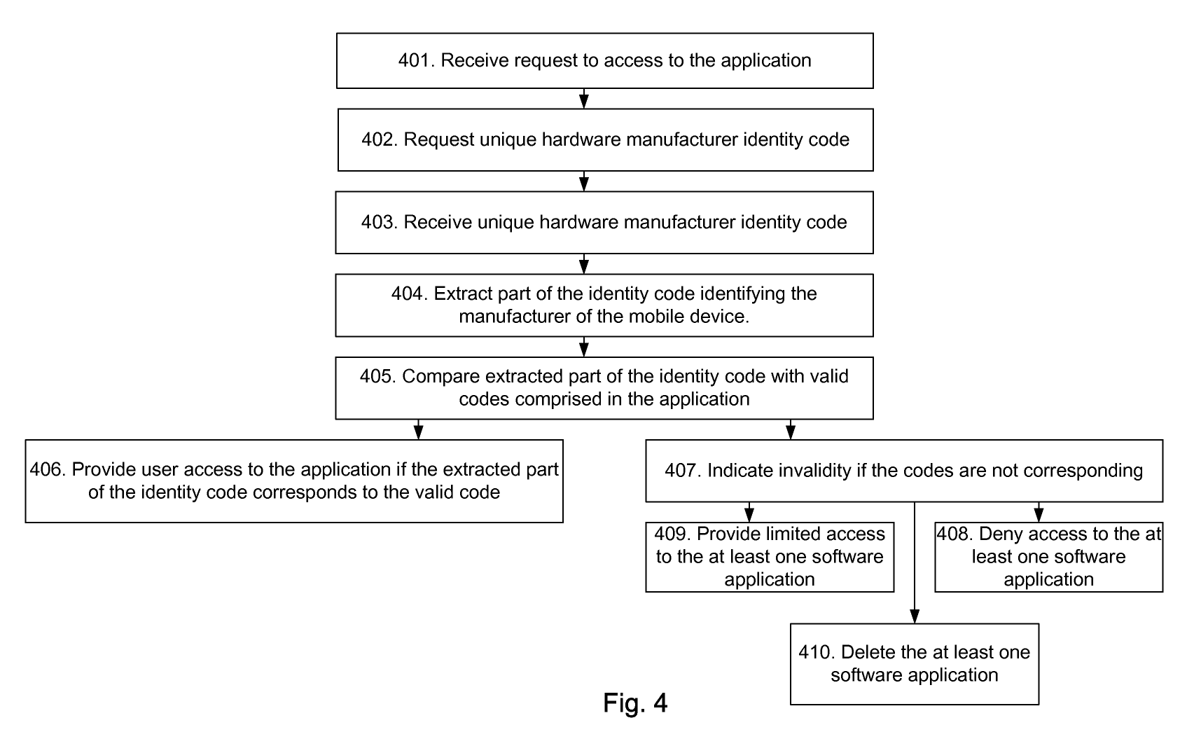

The method described above will now be described seen from the perspective of the application residing in mobile device 102. FIG. 4 is a flowchart describing the embodiments of the method performed in mobile device 102, for verifying valid access to at least one software application residing in mobile device 102.

Mobile device 102 includes a unique identifier (e.g., unique hardware manufacturer identity code), and the at least one software application maintains a list of a plurality of valid unique identifiers (e.g., hardware manufacturer identity codes). The method may include the following steps to be performed by the application in mobile device 102, which steps may as well be carried out in another suitable order than described below:

### Step 401

The software application receives a request to be accessed.

### Step 402

In response, the application requests the unique identifier (e.g., unique hardware manufacturer identity code) associated with the requesting device, for example, mobile device 102.

By way of example, the request may specify a plurality of types of unique identifiers, for example, a unique hardware manufacturer identity code substantially equivalent to an International Mobile Equipment Identity (IMEI).

### Step 403

The application receives a response from mobile device 102, which may include, among other things, the unique hardware manufacturer identity code provided.

### Step 404

The application extracts at least a relevant portion (and possibly, no other portion) of the identity code identifying the manufacturer of mobile device 102.

### Step 405

The application compares the extracted portion (e.g., and no other portions) of the identity code with valid codes comprised in the software application.

### Step 406

The application provides user 110 access to the at least one software application upon a determination that the extracted part of the identity code corresponds to the valid code.

### Step 407

By way of example, the application may indicate an invalidity if the code is not corresponding to the valid code.

### Step 408

By way of example, the application may deny access to the at least one software application if the code is not corresponding to the valid code.

### Step 409

By way of example, the application may provide a limited access to the at least one software application if the code is not corresponding to the valid code.

### Step 410

By way of example, the at least one software application may be deleted if the code is not corresponding to the valid code.

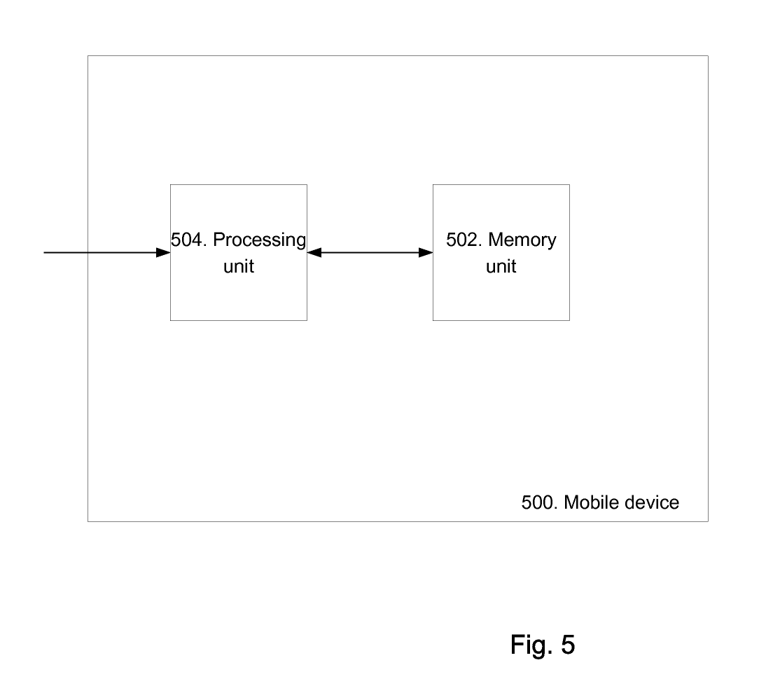

To perform the method steps shown in FIG. 4 for verifying valid access to at least one software application, mobile device 500 is provided as shown in FIG. 5. Mobile device 500 may include a unique hardware manufacturer identity code. The unique hardware manufacturer identity code may be an International Mobile Equipment Identity, “IMEI.” The at least one software application may include a list identifying at least one valid unique hardware manufacturer identity codes. Mobile device 500 may include a memory unit 502 storing the at least one software application. Memory unit 502 may include static memory, such as read only memory (ROM), and/or dynamic memory, such as random access memory (RAM), or onboard cache, for storing data and machine-readable instructions and applications. Mobile device 500 may also include a processing unit 504 adapted to receive a request to access the at least one software application, request the unique hardware manufacturer identity code of the mobile device, receive the unique hardware manufacturer identity code from the mobile device, extract at least a part of the identity code specifically identifying a manufacturer of the mobile device, compare the extracted part of the identity code with valid codes comprised in the software application, and provide access to the at least one software application if the extracted part of the identity code is valid.

By way of example, processing unit 504 may be further configured to indicate invalidity if the codes are not corresponding, and to deny access to the at least one software application if the codes are not corresponding. Processing unit 504 may be further configured to provide a limited access to the at least one software application if the codes are not corresponding. By way of example, processing unit 504 may be arranged to delete and/or disable the at least one software application if the codes do not correspond.

Processing unit 504 may include one or more processors, microprocessors, and/or processing logic capable of controlling mobile device 500. Processing unit 504 may execute applications stored in memory unit 502.

Mobile device 500 may also include radio frequency (RF) antennas, transceiver, modulator/demodulator, encoder/decoder etc. At least one power supply (not shown) may also be included in mobile device 500. The units comprised in mobile device 500 may be connected via one or more buses (not shown). A person skilled in the art would recognize that mobile device 500 may be configured in a number of other ways and may include other or different elements.

In other implementations, mobile device 500 may include fewer, additional, and/or different components than those illustrated in FIG. 5.

The present mechanism for verifying valid access to at least one software application residing in mobile device 500 may be implemented through one or more processors, such as processing unit 504 depicted in FIG. 5, together with computer program code for performing the functions of the present solution. The program code mentioned above may also be provided as a software application, for instance in the form of a data carrier carrying computer program code for performing the present solution when being loaded into the mobile device. One such carrier may be in the form of a CD ROM disc. It is however feasible with other data carriers such as a memory stick. The software application include computer-readable storage media for storing computer-executable instructions executable by processing logic, the media storing one or more instructions that when executed by the processing logic cause the processing logic to receive a request to access to the at least one software application; request the unique hardware manufacturer identity code of the mobile device; receive the unique hardware manufacturer identity code from the mobile device; extract at least a part of the identity code specifically identifying a manufacturer of the mobile device; compare the extracted part of the identity code with valid codes comprised in the software application; and provide access to the at least one software application if the extracted part of the identity code is valid.

The above-mentioned and described embodiments are only given as examples and should not be limiting to the present invention. Other solutions, uses, objectives, and functions within the scope of the invention as claimed in the below-described patent claims should be apparent for the person skilled in the art.

It should be noted that the terms “comprising,” “including,” and variants thereof, do not exclude the presence of other elements or steps than those listed and the words “a” or “an” preceding an element do not exclude the presence of a plurality of such elements. The invention can at least in part be implemented in either software or hardware. It should further be noted that any reference signs do not limit the scope of the claims, and that several “means,” “devices,” and “units” may be represented by the same item of hardware.

It should also be emphasized that the steps of the methods defined in the appended claims may, without departing from the present invention, be performed in another order than the order in which they appear in the claims.

What is claimed is:

1. A method for verifying valid access to a software application residing in a mobile device that includes a unique hardware manufacturer identity code, the at least one software application including a list identifying valid unique hardware manufacturer identity codes, the method comprising:
receiving a request to access to the software application;
requesting the unique hardware manufacturer identity code associated with the mobile device;
receiving, from the mobile device, the unique hardware manufacturer identity code;
extracting at least a portion, of the unique hardware manufacturer identity code, identifying a manufacturer of the mobile device;
comparing the extracted portion with the list identifying the valid unique hardware manufacturer identity codes; and
determining, based on a result of the comparison, whether and an extent to which access to the software application is to be granted.

2. The method according to claim 1, further comprising:
indicating invalidity when the extracted portion does not correspond to any of the valid unique hardware manufacturer identity codes.

3. The method according to claim 1, further comprising:
denying access to the software application when the extracted portion does not correspond to any of the valid unique hardware manufacturer identity codes.

4. The method according to claim 1, further comprising:
providing a limited execution of the software application when the extracted portion does not correspond to any of the valid unique hardware manufacturer identity codes.

5. The method according to claim 1, further comprising:
deleting the software application from the mobile device when the extracted portion does not correspond to any of the valid unique hardware manufacturer identity codes.

6. The method according to claim 1, further comprising:
disabling the software application from the mobile device when the extracted portion does not correspond to any of the valid unique hardware manufacturer identity codes.

7. The method according to claim 1, further comprising:
notifying the identified manufacture and/or an associate thereof, of a presence of the software application on the mobile device, when the extracted portion does not correspond to any of the valid unique hardware manufacturer identity codes.

8. The method according to claim 1, where the unique hardware manufacturer identity code is an International Mobile Equipment Identity (IMEI).

9. A mobile device for verifying valid access to at least one software application, the mobile device comprising a unique hardware manufacturer identity code, the at least one software application comprises a list of valid unique hardware manufacturer identity codes, the mobile device comprising a memory storing the at least one software application and including a processing unit to:
receive a request to access to the at least one software application;
request the unique hardware manufacturer identity code of the mobile device receive the unique hardware manufacturer identity code from the mobile device;
extract a part of the identity code specifically identifying a manufacturer of the mobile device;
compare the extracted part of the identity code with valid codes comprised in the software application; and
provide access to the at least one software application if the extracted part of the identity code is valid.

10. The device according to claim 9, where the processing unit is further to indicate invalidity if the code is not corresponding to the valid code.

11. The device according to claim 9, where the processing unit is further to deny access to the at least one software application if the code is not corresponding to the valid code.

12. The device according to claim 9, where the processing unit is further to provide a limited access to the at least one software application if the code is not corresponding to the valid code.

13. The device according to claim 9, where the processing unit is further to delete the at least one software application if the code is not corresponding to the valid code.

14. The device according to claim 9, where the processing unit is further to generate a notification to the identified manufacturer indicative of an invalid attempt to access the software application.

15. The device according to claim 9, where the unique hardware manufacturer identity code is an International Mobile Equipment Identity (IMEI).

16. A computer-readable storage device storing computer-executable instructions, executable by processing logic of a mobile device, including one or more instructions, that when executed by the processing logic, cause the processing logic to:
receive, from a mobile device, a request to access a software application;
send a request for a unique identifier associated with the mobile device;
receive, responsive to the sent request, the unique identifier from the mobile device;
extract a portion of the unique identifier identifying a manufacturer of the mobile device;
compare the identified manufacturer to a list of particular manufacturers, maintained by the software application, where the list comprises an exclusive listing of approved manufacturers for using the software application; and
provide access to the software application based on a result of the comparison.
